(19) United States
(12) Patent Application Publication
(10) Pub. No.: US 2024/0412445 A1
(43) Pub. Date: Dec. 12, 2024

(54) TRAVERSAL AND PROCEDURAL SHADER BOUNDS REFINEMENT

(71) Applicants: Advanced Micro Devices, Inc., Santa Clara, CA (US); ATI Technologies ULC, Markham (CA)

(72) Inventors: David William John Pankratz, Markham (CA); David Ronald Oldcorn, Milton Keynes (GB)

(73) Assignees: Advanced Micro Devices, Inc., Santa Clara, CA (US); ATI Technologies ULC, Markham (CA)

(21) Appl. No.: 18/332,562

(22) Filed: Jun. 9, 2023

(51) Int. Cl. G06T 15/06; G06T 15/00

(52) U.S. Cl. CPC G06T 15/06; G06T 15/005; G06T 2210/12; G06T 2210/21

(57) ABSTRACT

A technique for performing ray tracing operations is provided. The technique includes, traversing through a bounding volume hierarchy for a ray to arrive at a well-fit bounding volume that is associated with first node, wherein the first node is one of a traversal node or a procedural node, and wherein the well-fit bounding volume comprises geometry other than a single axis-aligned bounding box for the first node; evaluating the ray for intersection with the well-fit bounding volume; determining whether to execute a first shader program associated with the first node based on the evaluating, wherein the first shader program comprises a traversal shader program or a procedural shader program; and executing or not executing the first shader program based on the determining.

### BACKGROUND

Ray tracing is a type of graphics rendering technique in which simulated rays of light are cast to test for object intersection and pixels are colored based on the result of the ray cast. Ray tracing is computationally more expensive than rasterization-based techniques, but produces more physically accurate results. Improvements in ray tracing operations are constantly being made.

### BRIEF DESCRIPTION OF THE DRAWINGS

A more detailed understanding may be had from the following description, given by way of example in conjunction with the accompanying drawings wherein:

FIG. 1 is a block diagram of an example device in which one or more features of the disclosure can be implemented;

FIG. 2 is a block diagram of the device, illustrating additional details related to execution of processing tasks on the accelerated processing device of FIG. 1, according to an example;

FIG. 3 illustrates a ray tracing pipeline for rendering graphics using a ray tracing technique, according to an example;

FIG. 4 is an illustration of a bounding volume hierarchy, according to an example;

FIG. 5A illustrates a bounding volume hierarchy according to an example;

FIG. 5B illustrates a bounding volume hierarchy according to another example;

FIG. 6 illustrates a comparison between a first example in which a single axis-aligned bounding box is provided for a traversal node or procedural node and a second example in which a well-fit bounding volume is provided for a traversal node or procedural node; and

FIG. 7 is a flow diagram of a method for evaluating a ray against a scene including a well-fit bounding box, according to an example.

### DETAILED DESCRIPTION

A technique for performing ray tracing operations is provided. The technique includes, traversing through a bounding volume hierarchy for a ray to arrive at a well-fit bounding volume that is associated with first node, wherein the first node is one of a traversal node or a procedural node, and wherein the well-fit bounding volume comprises geometry other than a single axis-aligned bounding box for the first node; evaluating the ray for intersection with the well-fit bounding volume; determining whether to execute a first shader program associated with the first node based on the evaluating, wherein the first shader program comprises a traversal shader program or a procedural shader program; and executing or not executing the first shader program based on the determining.

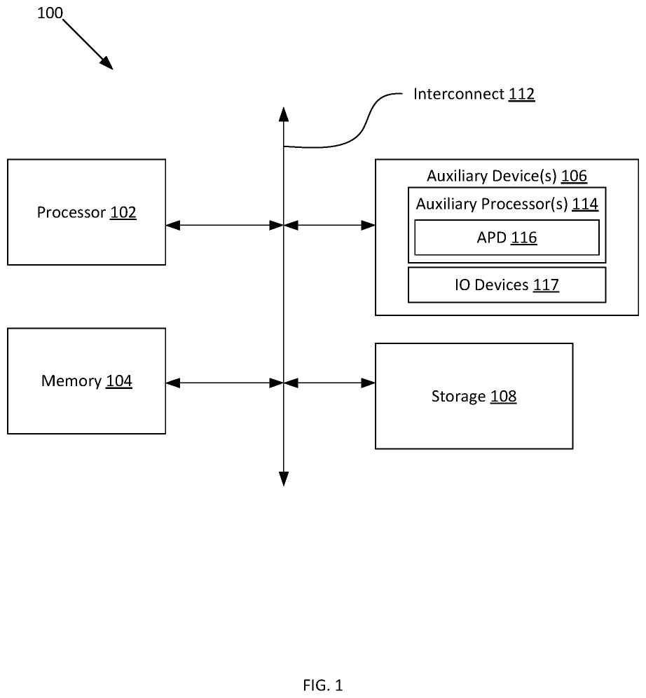

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

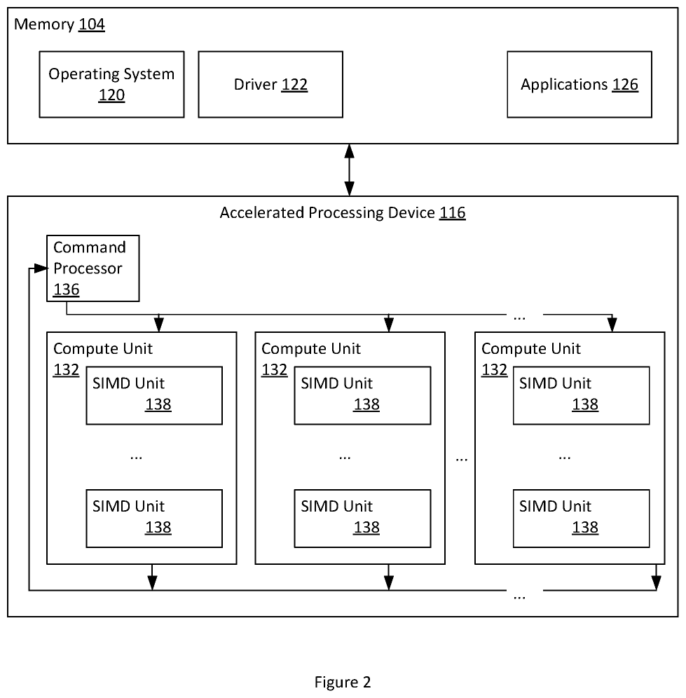

FIG. 2 is a block diagram of the device 100, illustrating additional details related to execution of processing tasks on the APD 116. The processor 102 maintains, in system memory 104, one or more control logic modules for execution by the processor 102. The control logic modules include an operating system 120, a driver 122, and applications 126. These control logic modules control various features of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. In some implementations, the driver 122 includes a just-in-time compiler that compiles programs for execution by processing components (such as the SIMD units 138 discussed in further detail below) of the APD 116. In other implementations, no just-in-time compiler is used to compile the programs, and a normal application compiler compiles shader programs for execution on the APD 116.

The APD 116 executes commands and programs for selected functions, such as graphics operations and non-graphics operations that are suited for parallel processing and/or non-ordered processing. The APD 116 is used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 (together, parallel processing units 202) that include one or more SIMD units 138 that perform operations at the request of the processor 102 in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but executes that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow. In an implementation, each of the compute units 132 can have a local L1 cache. In an implementation, multiple compute units 132 share a L2 cache.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group is executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 is configured to perform operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

The compute units 132 implement ray tracing, which is a technique that renders a 3D scene by testing for intersection between simulated light rays and objects in a scene. Much of the work involved in ray tracing is performed by programmable shader programs, executed on the SIMD units 138 in the compute units 132, as described in additional detail below.

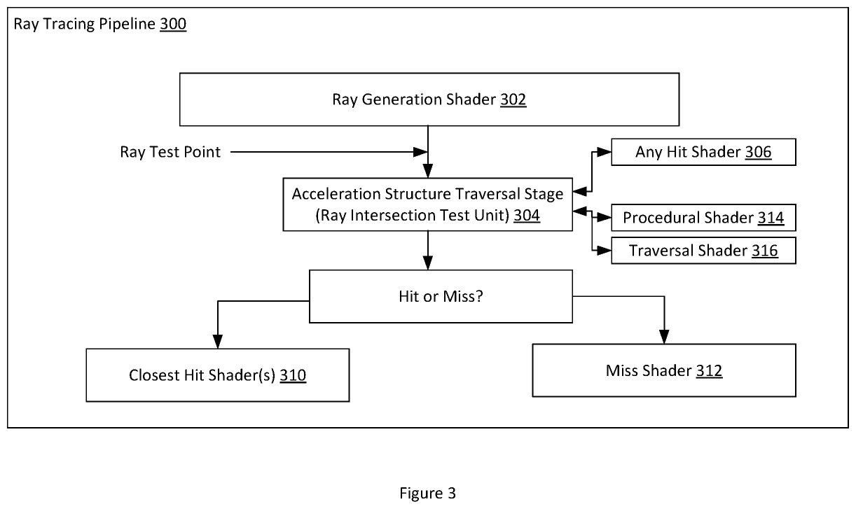

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, miss shader 312, procedural shader 314, and traversal shader 316 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122) or by code provided by some entity other than an application. The acceleration structure traversal stage 304 performs a ray intersection test to determine whether a ray hits a triangle.

The various programmable shader stages (ray generation shader 302, any hit shader 306, closest hit shader 310, miss shader 312, procedural shader 314, and traversal shader 316) are implemented as shader programs that execute on the SIMD units 138. The acceleration structure traversal stage 304 is implemented in software (e.g., as a shader program executing on the SIMD units 138), in hardware, or as a combination of hardware and software. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The acceleration structure traversal stage 304 determines whether the results of the acceleration structure traversal stage 304 (which may include raw data such as barycentric coordinates and a potential time to hit) actually indicates a hit. For non-opaque triangles that are hit, the ray tracing pipeline 300 may trigger execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. Regarding determining whether the results indicate a hit or a miss, the acceleration structure traversal stage 304 triggers execution of a closest hit shader 310 for the triangle closest to the origin of the ray that the ray hits, or, if no triangles were hit, triggers a miss shader 312.

Note, it is possible for the any hit shader 306 to “reject” a hit from the ray intersection test unit 304, and thus the acceleration structure traversal stage 304 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel.

It is possible for the closest hit shader 310 or the miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

As described above, the determination of whether a ray hits an object is referred to herein as a “ray intersection test.” The ray intersection test involves casting a ray from an origin and determining whether the ray hits a triangle and, if so, what distance from the origin the triangle hit is at. For efficiency, the ray tracing test uses a representation of space referred to as a bounding volume hierarchy. This bounding volume hierarchy is the “acceleration structure” described above. In a bounding volume hierarchy, each non-leaf node represents an axis aligned bounding box that bounds the geometry of all children of that node. In an example, the base node represents the maximal extents of an entire region for which the ray intersection test is being performed. In this example, the base node has two children that each represent mutually exclusive axis aligned bounding boxes that subdivide the entire region. Each of those two children has two child nodes that represent axis aligned bounding boxes that subdivide the space of their parent, and so on. Leaf nodes represent a triangle against which a ray test can be performed. It should be understood that where a first node points to a second node, the first node is considered to be the parent of the second node.

The bounding volume hierarchy data structure allows the number of ray-triangle intersections (which are complex and thus expensive in terms of processing resources) to be reduced as compared with a scenario in which no such data structure were used and therefore all triangles in a scene would have to be tested against the ray. Specifically, if a ray does not intersect a particular bounding box, and that bounding box bounds a large number of triangles, then all triangles in that box can be eliminated from the test. Thus, a ray intersection test is performed as a sequence of tests of the ray against axis-aligned bounding boxes, followed by tests against triangles.

A procedural shader 314 and traversal shader 316 are part of the ray tracing pipeline 300. The procedural shader 314 is a shader that performs an intersection test for a procedural leaf node. A procedural leaf node is a leaf node whose geometry is defined by a shader program. In other words, instead of being plain geometry such as a triangle, a procedural leaf node has extents defined procedurally, based on execution of a procedural shader program. In response to the acceleration structure traversal stage 304 determining that a ray intersects a bounding volume for a procedural leaf node, the acceleration structure traversal stage 304 triggers execution of a procedural shader program to determine whether the ray intersects the geometry associated with the procedural leaf node. In some examples, in the event that a procedural shader program determines that a ray intersects the leaf node associated with the procedural shader program, the acceleration structure traversal stage 304 performs additional activity such as executing an any hit shader program.

In some examples, a traversal shader 316 is a shader that constructs additional portions of a BVH in the event that the acceleration structure traversal stage 304 determines that a ray intersects a bounding volume for a traversal shader node. A traversal shader node is a non-leaf node of a BVH that specifies that a traversal shader program should be executed to generate additional BVH geometry for traversal. After the traversal shader program is executed and generates the additional portions of the BVH, the acceleration structure traversal stage 304 continues traversal of the BVH, which includes, in at least some instances, traversing through the additional portions of the BVH generated by the traversal shader program. It should be noted that traversal shaders are completely programmable and are not restricted to constructing a portion of a BVH. In an example, a traversal shader 316 can select a level of detail for a geometry instance that is the parent of a traversal shader node. In different examples, the geometry instance is or is not pre-built. In other examples, a traversal shader 316 can record the number of times that the traversal shader node is visited (i.e., how many times a ray traverses to that node). Any other technically feasible technique can be performed by a traversal shader 316. In some examples, a traversal shader 316 is a small modification to the procedural shader 314 where the traversal shader 316 has an additional capability that allows the traversal shader 316 to add nodes to the list of nodes to be traversed to by the acceleration structure traversal stage 304. In other words, in these examples, the traversal shader 316 is able to cause the acceleration structure traversal stage 304 traverse to additional nodes by adding those nodes to the data structure from which the acceleration structure traversal stage 304 fetches nodes to traverse.

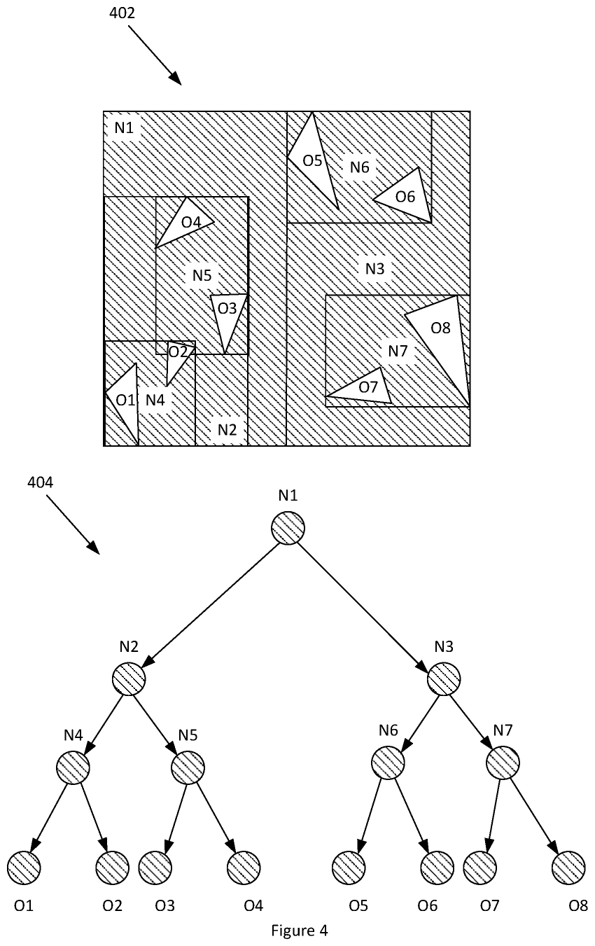

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the box test for that non-leaf node fails. For leaf nodes that are not eliminated, a ray-triangle intersection test is performed to determine whether the ray intersects the triangle at that leaf node.

In an example, the ray intersects O₅ but no other triangle. The test would test against N₁, determining that that test succeeds. In this example, the test would test against N₂, determining that the test fails. The test would eliminate all sub-nodes of N₂and would test against N₃, noting that that test succeeds. The test would test N₆ and N₇, noting that N₆ succeeds but N₇ fails. The test would test O₅ and O₆, noting that O₅succeeds but O₆ fails. Instead of testing 8 triangle tests, two triangle tests (O₅ and O₆) and five box tests (N₁, N₂, N₃, N₆, and N₇) are performed. Note that rays can have a variety of directions and can have an origin in a variety of locations. Thus, the specific boxes eliminated or not eliminated would depend on the origin and direction of the rays. However, in general, testing the rays for intersection with boxes eliminates some leaf nodes from consideration.

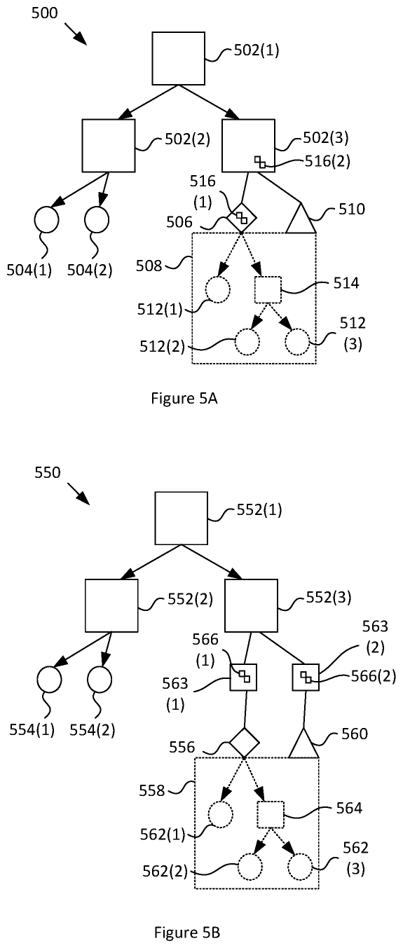

FIG. 5A illustrates a bounding volume hierarchy 500 according to an example. The bounding volume hierarchy 500 includes a plurality of non-leaf nodes 502, a plurality of leaf nodes 504, a traversal node 506, and a procedural leaf node 510. The non-leaf nodes 502 are similar to the non-leaf nodes N of FIG. 4. The leaf nodes 504 are similar to the leaf nodes O of FIG. 4.

The traversal node 506 represents a node that triggers a traversal shader program in the traversal shader stage 316, in order to build a new portion of the BVH. A built portion 508 of the BVH 500 is illustrated in dotted lines. The built portion 508 is built by executing the traversal shader program for the traversal node 506. The built portion 508 includes built leaf nodes 512 and a built non-leaf node 514. The built leaf nodes 512 are similar to the leaf nodes 504 and the built non-leaf nodes 514 are similar to the non-leaf nodes 502, with the exception that these built nodes are built as a result of traversal to the traversal node 506 and execution of the traversal shader.

The procedural node 510 is a leaf node whose geometry is defined procedurally (e.g., by executing a shader program in the procedural shader stage 314). In response to the acceleration structure traversal stage 304 determining that a ray intersects the bounding volume for the procedural node 510, the acceleration structure traversal stage 304 triggers execution of a procedural shader program associated with the procedural node 510 to determine whether the ray intersects the procedural node 510.

Procedural nodes 510 and traversal nodes 506 represent “expensive” operations for BVH traversal. More specifically, traversal through an already-built BVH, and intersection with leaf nodes with simple geometry (e.g., triangles) is relatively cheap and can be completed without execution of a shader program. By contrast, the traversal nodes 506 and procedural nodes 510 require execution of shader programs, which consume a relatively large amount of processing resources and cannot be completed in custom fixed function hardware that could be designed to accelerate evaluation of intersection with triangle nodes and bounding box non-leaf nodes.

For the above reasons, custom bounding volumes are included for procedural nodes 510 and traversal nodes 506. More specifically, bounding volumes are typically axis aligned bounding boxes, which can be represented as an intersection of six planes, where each such plane has a constant coordinate value in a single axis. However, such simple bounding volumes can vastly over-represent the volume occupied by underlying geometry. In such situations, false positives, in which a ray intersects the bounding volume but does not intersect any underlying geometry, represents wasted processing. Where the underlying geometry is associated with a procedural node 510 or a traversal node 506, such false positive would result in significant wasted processing effort, as those nodes require execution of expensive shader programs as described above. For at least these reasons, the present disclosure provides a technique to reduce false positives for procedural nodes 510 and traversal nodes 506.

Specifically, the procedural nodes 510 and traversal nodes 506 have associated well-fit bounding volumes 516 that are not necessarily axis aligned bounding boxes or that include multiple axis aligned bounding boxes. Regarding the traversal nodes 506, with “typical” non-leaf nodes, each non-leaf node is associated with a single axis aligned bounding box that bounds all geometry that is a child of that non-leaf node. In contrast with such “typical” nodes, the traversal nodes 506 are associated with well fit bounding volumes 516. Each such well-fit bounding volume 516 is not a single axis aligned bounding volume but includes bounding geometry that fits the underlying geometry (the geometry of the children) better than a single axis-aligned bounding box would. In some examples, “fitting underlying geometry better” means that the well-fit bounding volume 516 bounds less volume that is not occupied by any underlying geometry than an axis-aligned bounding box that tightly fits the underlying geometry. The underlying geometry for a traversal node 506 includes the geometry that would be generated by the traversal shader corresponding to the traversal node 506. The underlying geometry for a procedural node 510 includes the geometry that represents what shapes can be intersected by a ray.

Regarding the procedural nodes 510, which act as leaf nodes, “typical” leaf nodes are associated with a single axis aligned bounding box (e.g., in the parent of that leaf node) that bounds the geometry of the leaf node (e.g., a triangle). In contrast, the procedural nodes 510 are associated with well-fit bounding volumes 516 that, as with the well-fit bounding volumes 516 for the traversal nodes 506, fit the underlying geometry better than an axis-aligned bounding box would. More specifically, the well-fit bounding volumes 516 for the procedural nodes 510 has less space that is unoccupied by the underlying geometry of the procedural node 510 than an axis-aligned bounding box that tightly fits that underlying geometry would. The underlying geometry includes the geometry for which intersection with a ray can occur, when the procedural shader program is executed. In other words, as described above, the procedural node 510 represents a leaf node for which the test for intersection with a ray is defined by execution of a procedural shader program (i.e., execution of the procedural shader program determines whether the ray intersects the geometry of the procedural node 510). The well-fit bounding volume 516 for the procedural node 510 bounds the geometry that is represented by execution of the procedural shader program.

In summary, a BVH having procedural nodes 510 and traversal nodes 506 with well-fit bounding volumes 516 are provided. These well-fit bounding volumes 516 are better fit to the underlying geometry than an axis-aligned bounding box would be.

In some examples, the well-fit bounding volumes 516 are specified by an application or other entity. In other words, because the actual geometry of the procedural nodes 510 and traversal nodes 506 is specified programmatically, the bounds for such nodes are not readily apparent prior to evaluation by a procedural shader or traversal shader. Thus, an entity needs to explicitly specify a bounding volume for the underlying geometry. In some implementations, such nodes explicitly specify a corresponding well-fit bounding volume 516. More specifically, an application specifies certain geometry for a scene. Such geometry includes geometry associated with leaf nodes (e.g., triangles), geometry associated with procedural nodes (e.g., an indication of which procedural shader program to use to specify such leaf nodes), and geometry associated with traversal nodes (which can build a portion of a BVH, including leaf nodes). In specifying the traversal nodes and the procedural nodes, the application also specifies corresponding well-fit bounding volumes 516 (e.g., one such well-fit bounding volume for each traversal node and each procedural node). Using this information, a BVH builder is able to construct a full BVH, with a bounding volume hierarchy that includes the specified leaf nodes as well as the leaf nodes, the procedural nodes, and the traversal nodes. In addition, in the BVH, the procedural nodes and traversal nodes have the specified well-fit bounding volumes.

In traversing a BVH for a ray, where the BVH has either or both of procedural nodes and traversal nodes, the acceleration structure traversal stage 304 traverses the acceleration structure (e.g., testing against other types of non-leaf and leaf nodes), until arriving at a well-fit bounding volume 516. In response to arriving at a well-fit bounding volume 516, the acceleration structure traversal stage 304 tests the ray against the well-fit bounding volume 516 and executes the associated procedural shader program or traversal shader program. More specifically, if the well-fit bounding volume 516 is associated with a traversal node 506, the acceleration structure traversal stage 304 tests the ray against the well-fit bounding volume 516. If the ray does not intersect the well-fit bounding volume 516, then the acceleration structure traversal stage 304 does not trigger execution of the associated traversal shader. If the ray does intersect the well-fit bounding volume 516, then the acceleration structure traversal stage 304 triggers execution of the associated traversal shader program to build an additional portion of the BVH. Subsequently, the acceleration structure traversal stage 304 continues traversal of the BVH, including the constructed portion of the BVH.

If the well-fit bounding volume 516 is associated with a procedural node 510, the acceleration structure traversal stage 304 tests the ray against the well-fit bounding volume 516. If the ray does not intersect the well-fit bounding volume 516, then the acceleration structure traversal stage 304 does not trigger execution of the associated procedural shader program. If the ray does intersect the well-fit bounding volume 516, then the acceleration structure traversal stage 304 triggers execution of the associated procedural shader program to determine whether the ray intersects the leaf node.

In summary, the well-fit bounding volume 516 is a mechanism to prevent execution of a procedural shader program or a traversal shader program for a ray in the event that the ray does not intersect the well-fit bounding volume 516. The well-fit bounding volume 516 has less unoccupied space than an axis-aligned bounding box that tightly fits all underlying geometry. In some examples, “tightly fitting” means the smallest possible bounding box that encloses all underlying geometry.

FIG. 5B illustrates a bounding volume hierarchy 550 according to another example. In the example of FIG. 5B, the well-fit bounding volumes 566, which are similar to the well-fit bounding volumes 516, are within dedicated filter nodes 563. In response to the acceleration structure traversal stage 304 traversing to a filter node 563, the acceleration structure traversal stage 304 tests the ray against the well-fit bounding volume 566 of the filter node 563. In the event that the ray intersects the filter node 563, the acceleration structure traversal stage 304 proceeds to the node below the filter node 563 (e.g., the traversal node 556 or the procedural node 560). In the event that the ray does not intersect the filter node 563, then the acceleration structure traversal stage 304 does not traverse to any child of the filter node 563. It should be noted that the box nodes 552 are similar to the box nodes 502, the leaf nodes 554 are similar to the leaf nodes 504, the traversal node 556 is similar to the traversal node 506, the procedural node 560 is similar to the procedural node 510, and the built portion 558 is similar to the built portion 508 (e.g., including built box nodes 564 and build leaf nodes 562). The bounding volume hierarchy 550 is similar to the bounding volume hierarchy 500 except that the filter nodes 563 that are parents to traversal nodes 506 and procedural nodes 560 are present. In various examples of bounding boxes, filter nodes 563 are present and parent all or some traversal nodes 506 and/or all or some procedural nodes 560. The filter nodes 563 represent a low cost way to “filter out” traversals through to the procedural nodes 560 or traversal nodes 556.

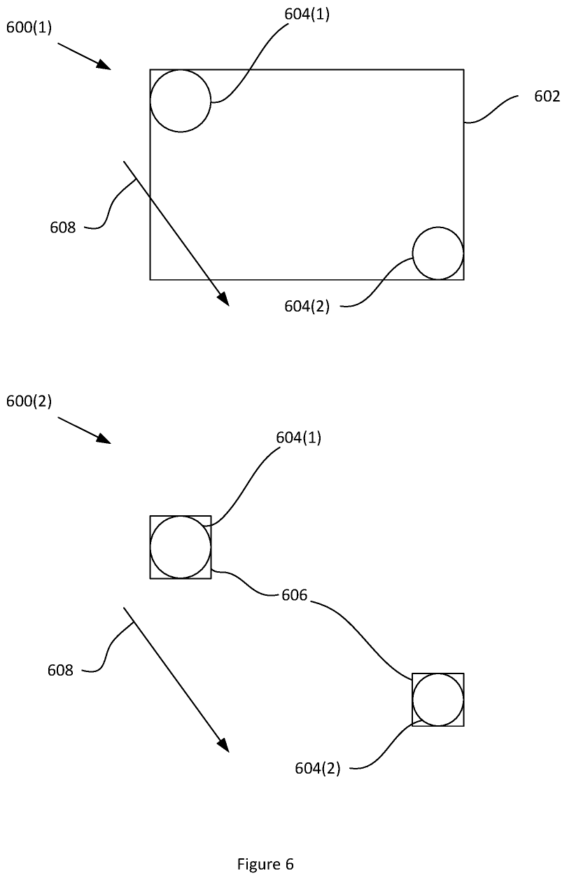

FIG. 6 illustrates a comparison between a first example 600(1) in which a single axis-aligned bounding box 602 is provided for a traversal node 506 or procedural node 510 and a second example 600(2) in which a well-fit bounding volume 606 is provided for a traversal node 506 or procedural node 510. Underlying geometry 604 is geometry that results from execution of the associated traversal node 506 or procedural node 510. More specifically, each example 600 includes a bounding volume for a single traversal node 506 or procedural node 510. Further, each example 600 includes underlying geometry 604 that results from the execution of a shader program. This underlying geometry 604 is be the procedurally defined primitive for a procedural node 510 or is the geometry (e.g., leaf nodes and/or non-leaf nodes) of the BVH constructed for a traversal node 506.

In the first example 600(1), a ray 608 intersects the axis-aligned bounding box 602. Because of this intersection, the acceleration structure traversal stage 304 triggers execution of the associated traversal shader program or procedural intersection shader program. As described above, such operations can be computationally expensive, especially if a portion of a BVH needs to be built. Because the ray 608 does not intersect the underlying geometry 604, the operations involved with executing such a shader program is wasted. By contrast, in the second example 600(2), because the ray 608 does not intersect the well-fit bounding volume 606, the acceleration structure traversal stage 304 does not trigger execution of the associated traversal shader program or procedural intersection shader program. Thus, the work associated with execution of such shader program is avoided, improving performance.

As described above, the well-fit bounding box 516 has geometry that is different than a single axis-aligned bounding box per procedural node 510 or traversal node 506. A well-fit bounding box 516 is, in various implementations, any technically feasible type of geometry. Some examples geometry types are as follows. One example geometry type for a well-fit bounding box 516 is k-discrete oriented polytope (“kDOP”). A kDOP is a geometric structure that is composed of an arbitrary number of planes, each of which is not necessarily axis-aligned, but which may be axis-aligned. Another example geometry type for a well-fit bounding box 516 is an axis-aligned bounding box treelet (“AABB treelet”). An axis-aligned bounding box treelet is a combination of axis-aligned bounding boxes that have a hierarchical relationship, with leaf axis-aligned bounding boxes at the bottom. To determine whether a ray intersects an AABB treelet, the acceleration structure traversal stage 304 traverses the non-leaf nodes of the treelet, eliminating from consideration children of non-leaf nodes that the ray does not intersect. Intersection occurs with the treelet if the ray intersects any leaf node. Another example geometry type for a well-fit bounding box 516 is a constructive solid geometry. A constructive solid geometry is an arbitrary shape that is composed of multiple other shapes (e.g., multiple spheres, cubes, etc., or a combination of different types of shapes). Another example geometry type for a well-fit bounding box 516 is a voxel grid. A voxel grid is a grid of voxels with an associated bitmask or other indication of occupied geometry. The bitmask or other indication indicates which voxels of the grid are considered occupied. If the ray intersects any occupied voxel, then the ray is considered to intersect the voxel grid. If the ray does not intersect any occupied voxel, then the ray is considered to not intersect the voxel grid.

In some examples, the well-fit bounding volume for a node is stored along with the data for a parent of that node. In other examples, the well-fit bounding volume for a node is stored in the node itself.

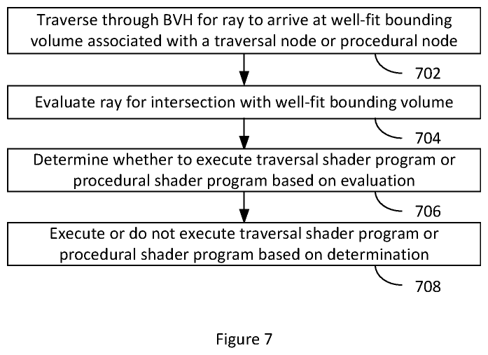

FIG. 7 is a flow diagram of a method 700 for evaluating a ray against a scene including a well-fit bounding box 516, according to an example. Although described with respect to the system of FIGS. 1-6, those of skill in the art will understand that any system configured to perform the steps of the method 700 in any technically feasible order falls within the scope of the present disclosure.

At step 702, an acceleration structure traversal stage 304 traverses through a bounding volume hierarchy for a ray. The traversal results in arrival at a well-fit bounding volume 516 which is associated with a traversal node 506 or a procedural node 510. In general, the traversal includes, starting with a root node, determining which nodes are ready for evaluation against the ray, determining which nodes are intersected by the ray, and repeating these steps until a termination condition occurs. For non-leaf nodes, the evaluation includes determining whether the ray intersects the non-leaf nodes, determining that the children of a non-leaf node are ready for evaluation if the ray intersects the non-leaf node, and determining that the children of a non-leaf node are not ready for evaluation if the ray does not intersect the non-leaf node. For leaf nodes, evaluation simply includes determining whether the ray intersects the leaf node. A variety of termination conditions exist. Some examples include that a closest hit has been found, if traversal is conducted in a closest hit mode, that any hit has been found if traversal is conducted in an any hit mode, that no hit has been found, or can include any other technically feasible termination condition. Step 702 occurs until arriving at a well-fit bounding volume 516 that is associated with a traversal node 506 or a procedural node 510.

At step 704, upon arriving at a well-fit bounding volume 516 that is associated with a traversal node 506 or a procedural node 510, the acceleration structure traversal stage 304 tests a ray for intersection with that well-fit bounding volume 516. As described elsewhere herein, the well-fit bounding volume 516 has any technically feasible geometry consistent with the present disclosure. In some examples, each well-fit bounding volume 516 is not a single axis-aligned bounding box, but may include multiple axis-aligned bounding boxes and/or may include other types of geometry, as described elsewhere herein. Testing whether the ray intersects the well-fit bounding volume 516 includes determining whether a part of the ray is within the well-fit bounding volume 516.

At step 706, the acceleration structure determines whether to execute a traversal shader program or procedural shader program based on the evaluation of step 704. Specifically, if the ray intersects a well-fit bounding volume 516, then the acceleration structure traversal stage 304 triggers execution of the traversal shader program or procedural shader program associated with that well-fit bounding volume 516. If the ray does not intersect the well-fit bounding volume 516, then the acceleration structure traversal stage 304 does not trigger execution of a shader program associated with that well-fit bounding volume 516. As described elsewhere herein, a well-fit bounding volume 516 being “associated with” a traversal shader program or a procedural shader program means that the BVH indicates that a ray must intersect with that well-fit bounding volume 516 in order for the acceleration structure traversal stage 304 to trigger execution of the traversal shader program or procedural shader program.

At step 708, based on the determination of step 706, the acceleration structure traversal stage triggers or does not trigger execution of a traversal shader program. Again, if the determination indicates that the ray intersects the well-fit bounding volume 516, then such shader program is executed and if the determination indicates that the ray does not intersect the well-fit bounding volume 516, then such shader program is not executed.

In summary, a bounding volume hierarchy is provided that includes one or both of traversal nodes and procedural nodes. In addition, the bounding volume hierarchy includes a well-fit bounding volume 516 for each such node. The well-fit bounding volume 516 prevent execution of the associated shader in the event that the ray does not intersect the well-fit bounding volume 516. By being “better fit” to the underlying geometry of the node, the well-fit bounding volume 516 prevents such shader programs from executing where the ray does not intersect the underlying geometry (e.g., a false positive) more often than with a single axis-aligned bounding box per node.

Each of the units illustrated in the figures represent hardware circuitry configured to perform the operations described herein, software configured to perform the operations described herein, or a combination of software and hardware configured to perform the steps described herein. For example, the ray tracing pipeline 300, ray generation shader 302, any hit shader 306, miss shader 312, closest hit shader 310, procedural shader 314, traversal shader 316, and acceleration structure traversal stage 304 are implemented fully in hardware, fully in software executing on processing units (such as compute units 132), or as a combination thereof. In some examples, the acceleration structure traversal stage 304 is partially implemented as hardware and partially as software. In some examples, the portion of the acceleration structure traversal stage 304 that traverses the bounding volume hierarchy is software executing on a processor and the portion of the acceleration structure traversal stage 304 that performs the ray-box intersection tests and ray-triangle intersection tests is implemented in hardware.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for performing ray tracing operations, the method comprising:
traversing through a bounding volume hierarchy for a ray to arrive at a well-fit bounding volume that is associated with first node, wherein the first node is one of a traversal node or a procedural node, and wherein the well-fit bounding volume comprises geometry other than a single axis-aligned bounding box for the first node;
evaluating the ray for intersection with the well-fit bounding volume; and
executing or not executing the first shader program based on a decision of whether to execute a first shader program associated with the first node based on the evaluating, wherein the first shader program comprises a traversal shader program or a procedural shader program.

2. The method of claim 1, wherein the geometry other than the single axis-aligned bounding box includes one of a k-discrete oriented polytope, an axis-aligned bounding box treelet, a constructive solid geometry, a voxel grid, or multiple axis-aligned bounding boxes.

3. The method of claim 1, wherein a shape of the geometry is specified by an application.

4. The method of claim 1, wherein evaluating the ray for intersection with the well-fit bounding volume includes determining whether at least a portion of the ray is within the well-fit bounding volume.

5. The method of claim 1, wherein the well-fit bounding volume includes a smaller amount of space that is unoccupied by underlying geometry of the first node than a single axis aligned bounding box that tightly fits all underlying geometry of the first node.

6. The method of claim 1, wherein the decision regarding whether to execute the first shader program based on the evaluating comprises determining to execute the first shader program in response to the ray intersecting the well-fit bounding volume.

7. The method of claim 1, wherein the decision regarding whether to execute the first shader program based on the evaluating comprises determining not to execute the first shader program in response to the ray not intersecting the well-fit bounding volume.

8. The method of claim 1, wherein the traversal shader program comprises a shader program that performs one of constructing an additional portion of the bounding volume hierarchy, or passing a pointer to pre-constructed geometry.

9. The method of claim 1, wherein the procedural shader program comprises a shader program that procedurally determines whether the ray intersects custom geometry of a leaf node.

10. A device for performing ray tracing operations, the device comprising:
a memory configured to store a bounding volume hierarchy; and
a processor configured to:
traverse through the bounding volume hierarchy for a ray to arrive at a well-fit bounding volume that is associated with first node, wherein the first node is one of a traversal node or a procedural node, and wherein the well-fit bounding volume comprises geometry other than a single axis-aligned bounding box for the first node;
evaluate the ray for intersection with the well-fit bounding volume; and
execute or not execute the first shader program based a decision of whether to execute a first shader program associated with the first node based on the evaluating, wherein the first shader program comprises a traversal shader program or a procedural shader program.

11. The device of claim 10, wherein the geometry other than the single axis-aligned bounding box includes one of a k-discrete oriented polytope, an axis-aligned bounding box treelet, a constructive solid geometry, a voxel grid, or multiple axis-aligned bounding boxes.

12. The device of claim 10, wherein a shape of the geometry is specified by an application.

13. The device of claim 10, wherein evaluating the ray for intersection with the well-fit bounding volume includes determining whether at least a portion of the ray is within the well-fit bounding volume.

14. The device of claim 10, wherein the well-fit bounding volume includes a smaller amount of space that is unoccupied by underlying geometry of the first node than a single axis aligned bounding box that tightly fits all underlying geometry of the first node.

15. The device of claim 10, wherein the decision regarding whether to execute the first shader program based on the evaluating comprises determining to execute the first shader program in response to the ray intersecting the well-fit bounding volume.

16. The device of claim 10, wherein the decision regarding whether to execute the first shader program based on the evaluating comprises determining not to execute the first shader program in response to the ray not intersecting the well-fit bounding volume.

17. The device of claim 10, wherein the traversal shader program comprises a shader program that constructs an additional portion of the bounding volume hierarchy, or passing a pointer to pre-constructed geometry.

18. The device of claim 10, wherein the procedural shader program comprises a shader program that procedurally determines whether the ray intersects custom geometry of a leaf node.

19. A non-transitory computer-readable medium storing instructions that, when executed by a processor, cause the processor to perform operations comprising:
traversing through a bounding volume hierarchy for a ray to arrive at a well-fit bounding volume that is associated with first node, wherein the first node is one of a traversal node or a procedural node, and wherein the well-fit bounding volume comprises geometry other than a single axis-aligned bounding box for the first node;
evaluating the ray for intersection with the well-fit bounding volume; and
executing or not executing the first shader program based on a decision of whether to execute a first shader program associated with the first node based on the evaluating, wherein the first shader program comprises a traversal shader program or a procedural shader program.

20. The non-transitory computer-readable medium of claim 19, wherein the geometry other than the single axis-aligned bounding box includes one of a k-discrete oriented polytope, an axis-aligned bounding box treelet, a constructive solid geometry, a voxel grid, or multiple axis-aligned bounding boxes.
